(19) United States
(12) Patent Application Publication
(10) Pub. No.: US 2009/0297025 A1
(43) Pub. Date: Dec. 3, 2009

(54) IMAGE PROCESSING DEVICE, IMAGE PROCESSING METHOD, AND STORAGE MEDIUM

(75) Inventors: Tsutomu Murayama, Yokohama-shi (JP); Kunio Yoshihara, Hachioji-shi (JP); Hiroyuki Kimura, Kawasaki-shi (JP); Shinichi Fukada, Kawasaki-shi (JP); Mineko Sato, Yokohama-shi (JP); Nobushige Nomura, Chigasaki-shi (JP); Makoto Fukumizu, Matsudo-shi (JP); Hirotsugu Matsumoto, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/464,493

(22) Filed: May 12, 2009

(30) Foreign Application Priority Data
Jun. 2, 2008 (JP) 2008-144710

(51) Int. Cl. G06K 9/00; G06K 9/34

(52) U.S. Cl. 382/167; 382/173

(57) ABSTRACT

An image processing device corrects brightness/hue in appearance of an object of interest while suppressing an effect of an optical illusion even if the object of interest is overlapped with a background part of any color. The image processing device includes an evaluation device that evaluates a record value of the object of interest and the background part thereof, a device that corrects the record value of the object of interest in order to correct the optical illusion of a human being according to a result of evaluation by the evaluation device, and a device that performs record with the record value after the correction.

### BACKGROUND OF THE INVENTION

1. Field of the Invention

The present invention relates to an image forming system that generates print data based on a prescribed printing controlling language in an information processing device, transmits the print data to an image forming device and forms an image according to the print data in the image forming device.

2. Description of the Related Art

As a kind of an optical illusion, identified is a phenomenon in which brightness/hue (tint) of a character string, a figure, or the like, looks different in the brightness/hue in appearance due to a difference of the brightness/hue of a background in the neighborhood. In these optical illusions, known are “brightness contrast” and “white optical illusion” which are due to the brightness, and “color contrast” and “Munker optical illusion” which are due to the hue.

As an example in which such an illusion is suppressed, Japanese Patent Laid-Open No. 2006-180380 deals with how the width of a line against a background image looks to have a different thickness depending on the color of the background. In order to solve this subject, in this document, it is disclosed that brightness/color information of the background image are detected and according to the result, a record and display is performed with the original line width changed, and thereby, the optical illusion of the line width is suppressed.

However, although there is an effect of the optical illusion suppressing for the line width in Japanese Patent Laid-Open No. 2006-180380, the suppressing effect on other various optical illusions is not acquired.

In particular, there is such a problem that, in the case of there being objects of the same color existing on the same screen, the objects do not look as the same color due to the optical illusion caused because the background color of each object is different, as that an object surrounded by a dark background looks pale compared with one surrounded by a white background. For example, in a so-called variable printing which performs overlapping printing (print with insertion) of different objects successively on a master document, it was very complicated and a great burden for a user to perform print processing while checking and correcting the each combination visually in order to suppress such optical illusion.

### SUMMARY OF THE INVENTION

A present invention provides with an image processing device comprising: an evaluation unit for evaluating a record value of an object of interest and a background part thereof; a unit for correcting the record value of the object of interest in order to correct an optical illusion of a human depending on a result of the evaluation by the evaluation unit; and a unit for performing record with the corrected record value.

A present invention provides with an image processing device, comprising: an evaluation unit that evaluates a record value of a second object in the neighborhood of a first object; a unit that corrects the record value of the first and the second object in order to correct an optical illusion of a human depending on a result of the evaluation by the evaluation unit; and a unit that performs record with the corrected record value.

A present invention provides with an image processing method performed in an image processing device, the method comprising the steps of: evaluating a record value of an object of interest and a background part thereof; correcting the record value of the object of interest in order to correct an optical illusion of a human depending on a result of the evaluation by the evaluation step; and performing record with the corrected record value.

A present invention provides with an image processing method performed in an image processing device, the method comprising the steps of: evaluating a record value of a second object in the neighborhood of a first object; correcting the record value of the first and the second object in order to correct an optical illusion of a human depending on a result of the evaluation by the evaluation step; and performing record with the corrected record value.

Further features of the present invention will become apparent from the following description of exemplary embodiments (with reference to the attached drawings).

### BRIEF DESCRIPTION OF THE DRAWINGS

FIG. 1 illustrates an overall configuration of an image forming system 10 according to a first embodiment of the present invention;

FIG. 2 illustrates an engine part 1040 of the image forming system 10 described above;

FIG. 3 is a flow chart illustrating print processing with an optical illusion corrected in the first embodiment of the present invention;

FIG. 4 illustrates an example of a LUT which indicates a change amount of luminance in appearance due to the optical illusion in the first embodiment of the present invention;

FIG. 5 illustrates an example of a correction LUT for calculating a value (a correction value) of the luminance to be corrected;

FIG. 6 is a flow chart illustrating correction judgment processing of an object in the first embodiment of the present invention;

FIG. 7 illustrates an example of a process for extracting a background which overlaps the object in the first embodiment of the present invention;

FIG. 8 is a flow chart illustrating correction processing of the object in the first embodiment of the present invention;

FIG. 9 illustrates a correction result of the optical illusion in the first embodiment of the present invention;

FIG. 10 illustrates an example in which the correction of the optical illusion is performed with the object decomposed in a fourth embodiment of the present invention;

FIG. 11 is a flow chart illustrating the correction processing of the object in the second embodiment of the present invention;

FIG. 12 illustrates an example of a luminance correction screen of the object displayed on a panel 2002 in the second embodiment of the present invention;

FIG. 13 is a flow chart illustrating the print processing with the optical illusion corrected in a variable print in the third embodiment of the present invention;

FIG. 14 illustrates judging process whether an object of interest has overlapped with other objects in the first embodiment of the present invention;

FIG. 15 is a flow chart illustrating the print processing with the optical illusion corrected in the second embodiment of the present invention;

FIG. 16 is a flow chart illustrating the print processing with the optical illusion corrected in the fifth embodiment of the present invention;

FIG. 17A illustrates the correction result of the optical illusion in the fifth embodiment of the present invention;

FIG. 17B illustrates the correction result of the optical illusion in the fifth embodiment of the present invention;

FIG. 17C illustrates the correction result of the optical illusion in the fifth embodiment of the present invention; and

FIG. 18 is a flow chart illustrating the correction processing of the object in the fifth embodiment of the present invention.

### DESCRIPTION OF THE EMBODIMENTS

Hereinafter, embodiments of the present invention will be described with reference to figures. However, a component described in these embodiments is merely an exemplification to the last, and is not purported to limit the scope of the invention thereto.

### First Embodiment

### <Description of an Overall Configuration of an Image Forming System>

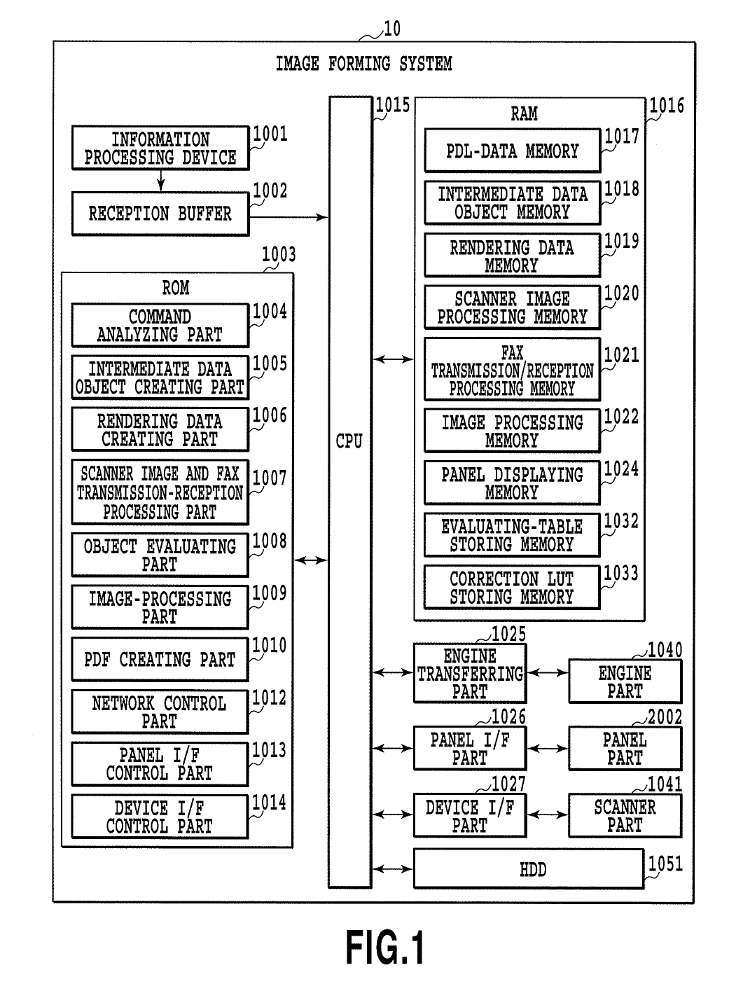

First, an overall configuration of an image forming system 10 according to a first embodiment of the present invention will be described. FIG. 1 illustrates the overall configuration of the image forming system 10 according to the present embodiment.

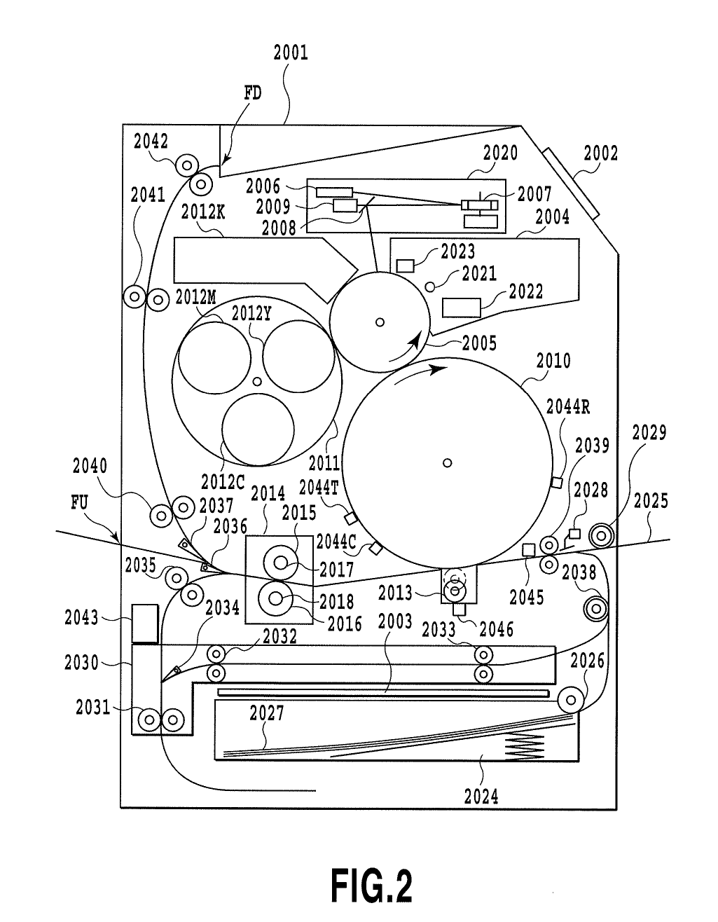

The image forming system 10 includes roughly: a controller (CPU) 1015 which controls each part indicated by reference numerals 1002 to 1033 in the image forming system 10; an engine part 1040 (described later using FIG. 2); a panel part 2002; and a scanner part 1041.

Reference numeral 1001 denotes an information processing device which transmits a print job. This information processing device 1001 is connected with a receiving buffer 1002 via a network by a cable. As the network utilized, there is Ethernet (registered trademark) generally.

Data sent from the information processing device 1001 is stored in the receiving buffer 1002 temporarily. Reference numeral 1003 denotes a ROM in which a program of the image forming system 10 is stored. The programs stored in the ROM 1003 are as follows.

A command analyzing part 1004 analyzes a command of a PDL (Page Description Language) which is a printing controlling language. An intermediate data object creating part 1005 performs drawing processing, and creates an intermediate data object from a PDL data stored in a PDL-data memory 1017 on a RAM 1016 and stores the created object in an intermediate data object memory 1018 on the RAM 1016.

A rendering data creating part 1006 performs rendering processing.

Specifically, the intermediate data object stored in the intermediate data object memory 1018 on the RAM 1016 is converted into the rendering data (bit map data). Then, the converted rendering data are stored in a rendering data memory 1019 on the RAM 1016.

A scanner image and FAX transmission-reception processing part 1007 performs a prescribed process for the scanner image and FAX transmission-reception data. An image-processing part 1009 performs color processing and screen processing before giving the image data to the engine part 1040. A PDF preparing part 1010 creates the data of a portable data format (PDF (registered trademark)).

A network control part 1012 performs network control. A panel I/F control part 1013 controls a panel I/F part 1026 which is an interface with the panel part. A device I/F control part 1014 controls a device I/F part 1027 which is the interface with the scanner part 1041. Above function parts are stored in the ROM 1003 as the programs.

Subsequently, reference numeral 1015 denotes a CPU of the image forming system 10. The CPU is a controller which controls the overall image forming system 10. Reference numeral 1016 denotes a RAM used with the image forming system 10. Memory areas described in the following are included in the RAM 1016.

The PDL-data memory 1017 stores command-analysis data analyzed by the command analyzing part 1004. The intermediate data object memory 1018 stores the intermediate data object created by the intermediate data object creating part 1005 from the PDL data stored in the PDL-data memory 1017. The rendering data memory 1019 stores the rendering data created by the rendering data creating part 1006 from the intermediate data object stored in the intermediate data object memory 1018. A scanner image processing memory 1020 is a memory area used by a scanner image process. A FAX transmission-and-reception processing memory 1021 is the memory area used by the FAX transmission and reception process. An image processing memory 1022 is the memory area used by the image processing. A panel displaying memory 1024 is the memory area used by panel displaying. An evaluating-table storing memory 1032 stores the data (the LUT which indicates a change amount of luminance in appearance due to an optical illusion) for judgment used in the case of correcting the optical illusion. A correction LUT (look-up table) storing memory 1033 stores the data (correction LUT) for correcting the optical illusion. The above memory areas are included in the RAM 1016.

Reference numeral 1040 denotes the engine part (described later using FIG. 2). Reference numeral 1025 denotes an engine transferring part which transfers the bit map information to this engine part 1040. Reference numeral 1026 denotes the panel I/F part which transfers panel information to the panel part 2002. Reference numeral 1027 denotes the device I/F part which communicates with the scanner part 1041. Reference numeral 2002 denotes the panel part which performs display, or the like. Reference numeral 1041 denotes the scanner part which reads a manuscript image. Reference numeral 1051 denotes a HDD (hard disk drive).

<Description of the Engine Part of the Image Forming System 10>

The detail of the engine part 1040 of the image forming system 10 will be described using FIG. 2.

FIG. 2 illustrates a configuration of the engine part 1040 of the image forming system 10.

The engine part 1040 is provided with a housing 2001 as illustrated in FIG. 2. Each mechanism configuring the engine part 1040 is built-in in the housing 2001.

There are the followings as mechanisms configuring the engine part 1040. One is an optical process mechanism for forming an electrostatic latent image on a photosensitive drum 2005 by scanning a laser beam, developing the electrostatic latent image, performing a multi layer transfer of the developed image to an intermediate transfer body 2010, and transferring the multi-layer-transferred color image further to a transfer material 2027. In addition, provided are a fixing process mechanism for fixing a toner image transferred to the transfer material 2027, a paper feeding process mechanism which feeds the transfer material, and a carrying processing mechanism which carries the transfer material.

A laser scanner part 2020 has a laser driver (not shown) to on-off-drive the laser beam projected from a semiconductor laser 2006 corresponding to the image data supplied from a CPU 1015 via the engine transferring part 1025. The laser beam projected from the semiconductor laser 2006 is scanned in the scanning direction with a rotating polygon mirror 2007. The laser beam scanned in the main scanning direction is guided to the photosensitive drum 2005 via a reflective mirror 2008, and the outer surface of the photosensitive drum 2005 is exposed to the main scanning direction.

The photosensitive drum 2005 is charged with a primary charging instrument 2023, and the electrostatic latent image is formed on the photosensitive drum 2005 owing to the scanning exposure with the laser beam. Then, the latent image is developed into the toner image with the toner supplied in a developing part. The toner image, with a voltage reverse to this toner image impressed, is transferred on the intermediate transfer body 2010 from the surface of the photosensitive drum 2005 (primary transfer). In the case of forming a color image, a developing rotary 2011 rotates for every one revolution of the intermediate transfer body 2010, and a developing process is performed in the order of a yellow developing device 2012Y, a magenta developing device 2012M, a cyan developing device 2012C, and subsequently, a black developing device 2012K. Then, the intermediate transfer body 2010 rotates four times, and each visible image of yellow, magenta, cyan, and black are formed one by one, and a full color visible image is formed on the intermediate transfer body 2010 as the result.

In the case of the formation of a monochrome image, the developing process is performed only with the black developing device 2012K, and the black visible image is formed with the intermediate transfer body 2010 rotated one time, and the monochrome visible image is formed on the intermediate transfer body 2010 (primary transfer).

As for the toner image formed on the intermediate transfer body 2010, the transfer material 2027 having been made to standby at a resist shutter 2028 is carried, and is contacted by pressure to the intermediate transfer body 2010 by a transfer roller 2013. At the same time as this, with the bias reverse to the toner impressed to the transfer roller 2013, the toner image is transferred to the transfer material 2027 fed by the paper feeding process mechanism in synchronizing with the sub-scanning direction (secondary transfer).

The photosensitive drum 2005 and the yellow developing device 2012Y, the magenta developing device 2012M, the cyan developing device 2012C and subsequently the black developing device 2012K, are detachable. The developing devices other than the black are contained in the developing rotary 2011. The reflective mirror 2008 has a semi-transmissive mirror, and a beam detector 2009 is placed at the side of the rear-face. The beam detector 2009 detects the laser beam and the detection signal is given to the CPU 1015 via an engine transfer part 1025.

The CPU 1015 generates a horizontal synchronizing signal which determines a exposure timing in the main scanning direction based on the detection signal of the beam detector 2009 sent via the engine transferring part 1025. The horizontal synchronizing signal is outputted to the engine transferring part 1025. Reference numeral 2022 denotes a cleaner which removes the remaining toner on the photosensitive drum 2005. Reference numeral 2021 denotes a pre-exposure lamp which neutralizes the photosensitive drum 2005.

The transfer roller 2013 is movable in an up-and-down direction as illustrated in the figure, and has a driving mechanism. While the toner image of four color is formed on the intermediate transfer body 2010 as mentioned above, that is, while the intermediate transfer body 2010 rotates more than once, the transfer roller 2013 is located down below so as not to disturb the image as illustrated by a continuous line in the figure, and is separated from the intermediate transfer body 2010. After the formation of the toner image of four colors on the intermediate transfer body 2010 has been completed, the transfer roller 2013 is moved to the upper position illustrated by a dotted line in the figure by a not shown cam member according to the timing at which the color image is transferred to the transfer material 2027. That is, the transfer roller 2013 is pressed against the intermediate transfer body 2010 by a predetermined pressure via the transfer material 2027. At this time and at the same time, a bias voltage is impressed to the transfer roller, and the toner image on the intermediate transfer body 2010 is transferred to the transfer material 2027.

Reference numeral 2046 denotes a transfer roller cleaner. The transfer roller cleaner performs cleaning in the case that the toner of the intermediate transfer material printed in the range exceeding the size of the transfer material has adhered to the transfer roller. Various sensors are disposed around the intermediate transfer body. Specifically, disposed are an image formation start position detection sensor 2044T for determining the printing start position at the time of performing image formation, a paper feeding timing sensor 2044R for determining the timing of paper feeding of the transfer material, and a density sensor 2044C for determining density of a patch at the time of density control. When the density control is performed, the density measurement of each patch is performed by this density sensor.

The fixing process mechanism has a fixing device 2014 for making the toner image transferred to the transfer material 2027 being fixed by hot pressing. The fixing device 2014 includes a fixing roller 2015 for applying heat to the transfer material 2027 and a pressurizing roller 2016 for making the transfer material 2027 contact by pressure to the fixing roller 2015. Each of these rollers is a hollow roller, and has heaters 2017 to 2018 in the inside thereof, and carries the transfer material 2027 simultaneously when the rollers are driven and rotated. Reference numeral 2045 detects a type of the transfer material automatically, and is a transfer material discrimination sensor for enhancing fixability, and switches a carrying time of the transfer material by adjusting the time in which the transfer material passes through the fixing device depending on the properties of the transfer material.

A feeding mechanism for the transfer material has a cassette 2024 which store the transfer material 2027 and a hand-feed tray 2025, and feeds selectively the transfer material of the cassette 2024 or the transfer material of the hand-feed tray 2025. The cassette 2024 is installed in the housing 2001, and in the cassette 2024, provided is a size detecting mechanism which detects the size of the transfer material electrically according to the movement position of a partition plate (not shown). From the cassette 2024, the transfer material is carried to a feed roller 2038 by rotating and driving of a cassette paper-feeding clutch 2026 in a one-sheet unit from the top of the transfer materials. The cassette paper-feeding clutch 2026 includes a cam driven and rotated intermittently by the driving mechanism (not shown) for every paper feeding and the transfer material of one sheet is fed whenever the cam rotates once.

The feed roller 2038 carries the transfer material up to the position where the tip part thereof corresponds to the resist shutter 2028. The resist shutter 2028 performs stopping and releasing of the feeding of the transfer material according to the pressing and the releasing of the fed transfer material, and the operation of this resist shutter 2028 is controlled so as to synchronize with the sub-scanning of the laser beam. On the other hand, the hand-feed tray 2025 is provided in the housing 2001, and the transfer material loaded in the hand-feed tray 2025 by a user is fed towards the resist shutter 2028 by the feed roller 2029.

The carrying processing mechanism of the transfer material has a carrying roller 2039 carrying the transfer material released from the pressing by the resist shutter 2028 towards the intermediate transfer body 2010. Furthermore, the carrying processing mechanism has flappers 2036 and 2037 for guiding the transfer material ejected from the fixing device 2014 to a paper ejection tray FD formed in the upper part of the housing 2001. Furthermore, the carrying processing mechanism has carrying rollers 2040, 2041, and 2042, and the driving mechanism (not shown) for driving the carrying rollers 2040, 2041, and 2042.

The flapper 2037, by the switching thereof, can switch the paper ejection part that is the paper ejection tray FD formed in the upper part of the housing 2001 or a paper ejection tray FU formed in the side surface of the housing 2001. It also becomes possible by switching the flapper 2036 to perform double-sided printing. Reference numeral 2030 is an inverting feed unit. The inverting feed unit has engine carrying rollers 2031, 2032, 2033 and a flapper 2034.

To the housing 2001, the panel part 2002 for display, or the like, is attached. Reference numeral 2043 is an external memory unit and is an external memory utilized for storage of printing data, or the like.

<Description of General Image Forming Process>

A printing operation in the system configuration mentioned above will be described in the following.

In the information processing device 1001, when execution of printing is instructed by an instruction of the user (operator), a control code and data are transmitted from the information processing device 1001 via the network cable. The control code and data having come via the receiving buffer 1002 is command-analyzed according to the program stated in the command analyzing part 1004, and is stored in the PDL-data memory 1017.

After that, processing the data is performed according to the program stated in the intermediate data object creating part 1005 and generated is the intermediate data object with respect to each of image objects such as a figure and a character, image data, or the like.

After the intermediate data object is generated with respect to all the image objects in one page, the intermediate data objects are developed into the rendering data (bit map data) according to the program stated in the rendering data creating part 1006.

The developed bit map data, with a color conversion and the screen processing performed thereon in the image-processing part 1009, is sent to the engine part 1040 via the engine transferring part 1025. Then, the feeding is performed from a specified feed port, and printing is performed on the transfer material by the engine part 1040, and the printed transfer material will be ejected from a specified ejecting port.

<Print Processing in which an Optical Illusion is Corrected>

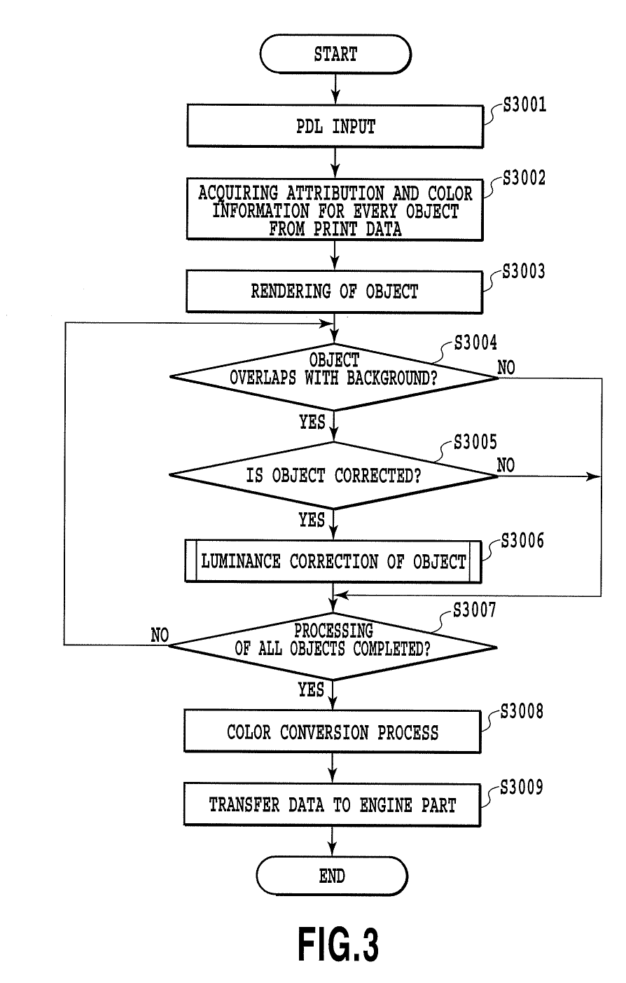

Hereinafter, the print processing which performs correction for reducing the optical illusion in the first embodiment of the present invention will be described according to a flow chart of FIG. 3 with reference to FIG. 1 and FIG. 2. This process is performed by the CPU 1015.

The image data transmitted from the information processing device 1001 via a printer driver is inputted, in the PDL format, into the CPU 1015 via the receiving buffer 1002 (S3001).

The CPU 1015 performs processing of the data according to a program stated in the intermediate data object creating part 1005. Here, with respect to each of the image objects such as a figure and a character, image data, or the like, the intermediate data object is generated in the intermediate data object memory 1018. At the same time, attribution information of each object is acquired from the PDL data (S3002). In the attribution information of this object, position information, size information, and color information are included.

After the intermediate data object is generated in the intermediate data object memory 1018 with respect to all the image objects in one page, the rendering processing is performed. Specifically, the intermediate data object is developed into the rendering data (bit map data) in the rendering data memory 1019 according to the program stated in the rendering data creating part 1006 (S3003).

Subsequently, with respect to an object of interest, it is detected whether the object of interest is overlapped with other objects based on the position information and the size information included in the attribution information of the object in the PDL-data memory 1017 (S3004). The detail will be described later in the item <Judgment whether an object has overlapped with a background>. In the present embodiment, since an example of the processing on the basis of white (luminance is the maximum) is described using the luminance of the object as a record value, it is judged whether the object of interest has overlapped with other objects of the color other than the white. In the case that it is judged that the object of interest has not overlapped with the other objects, the process progresses to the process of step S3007. In the present description, the object on the most back surface is henceforth defined as the background (background image).

In the case that it is judged that the object of interest has overlapped with other objects of the color other than the white or the background based on the detection in S3004, correction judgment processing of the object of interest is performed (S3005). The detail of this process will be described in the item <Judgment whether to perform correction of an object >. As the result of this judging process, in the case that it is judged that the correction is not to be performed, the process progresses to the process of step S3007.

In the case that it is judged that the correction is performed, the correction of the luminance (record value) of the object of interest is performed (S3006). The detail of this process will be described later in the item <Luminance correction of an object>.

Likewise, with respect to all the objects, correction judgment and correction processing (steps S3004 to S3006) are performed (S3007).

If processing is completed with respect to all the objects, a color conversion process are performed by reflecting brightness information of the corrected color which has been altered by step S3006 in the image-processing part 1009, and after that, the screen processing is performed (S3008). A record signal on which the correction of the optical illusion has been performed by the above processing is sent to the engine part 1040 via the engine transferring part 1025 (S3009).

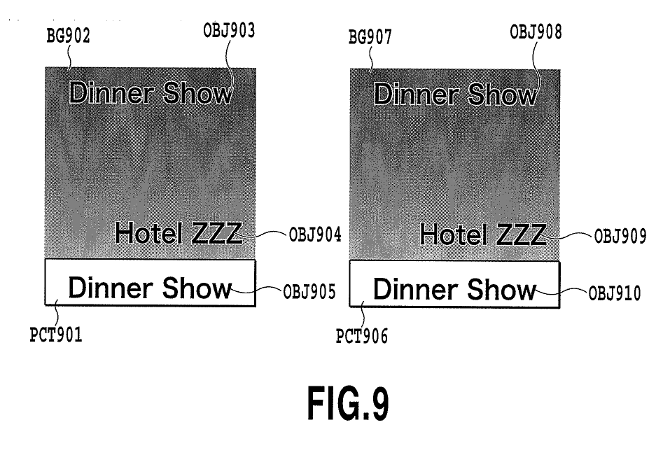

An example of the correction result of the optical illusion in the present embodiment is illustrated in FIG. 9.

In FIG. 9, reference character PCT901 denotes an overall image data. Reference character PCT901 includes a background data BG902, character objects OBJ903, OBJ904, and OBJ905. Reference character PCT906 denotes an overall print data created by performing the correction processing of the optical illusion on the image data PCT901. A background BG907, character objects OBJ908, OBJ909, and OBJ910 are printed.

Although the character objects OBJ903 and OBJ905 in the image data PCT901 are the data having the same luminance, the character object OBJ903 looks bright in appearance since the luminance of the background is different.

Then, in the print data PCT906 created by performing the correction processing of the optical illusion of the present embodiment, each luminance (R, G, B) of three primary colors R, G, and B into which the color of the character object OBJ908 has been color-separated is corrected from (180, 180, 180) to (145, 155, 150). As a result, the brightness of the character object OBJ908 looks to be the same brightness in appearance as the character object OBJ910 on the white background image.

<Judgment whether an Object has Overlapped with a Background>

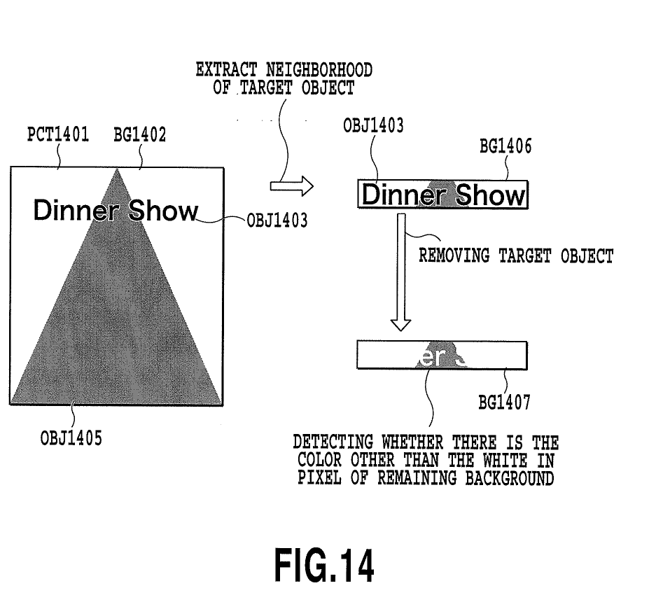

Next, a judging process of whether an object has overlapped with a background will be described using FIG. 14.

FIG. 14 illustrates an example of step S3004 which judges whether a certain object has overlapped with other objects or a background. In the present embodiment, since an example of the processing on the basis of the white (luminance is the maximum) is described, it is judged whether the certain object has overlapped with other objects of the color other than the white.

In FIG. 14, reference character PCT1401 is an overall image data and includes a background data BG1402, a character object OBJ1403, and a triangle graphic object OBJ1405. Here, the process which judges whether the other objects and the background have overlapped on the character object OBJ1403 is illustrated.

First, the CPU 1015 extracts all the pixels in a neighborhood area BG1406 of the character object OBJ1403 from the position information and the size information of the character object OBJ1403 which are included in the attribution information of these objects in the PDL-data memory 1017.

Next, the pixels of the character object OBJ1403 are extracted from the neighborhood area BG1406, and if pixels other than the white are included in the pixels in the background BG1407 of the remaining portion, it is judged that the other objects or the background have overlapped with the character object OBJ1403. Here, in the process which extracts the neighborhood of the object, a certain number or length of the pixels of the object may be judged to be the neighborhood, and a certain percentage of a vertical and horizontal length of the object may be judged to be the neighborhood.

<Judgment whether to Perform Correction of an Object>

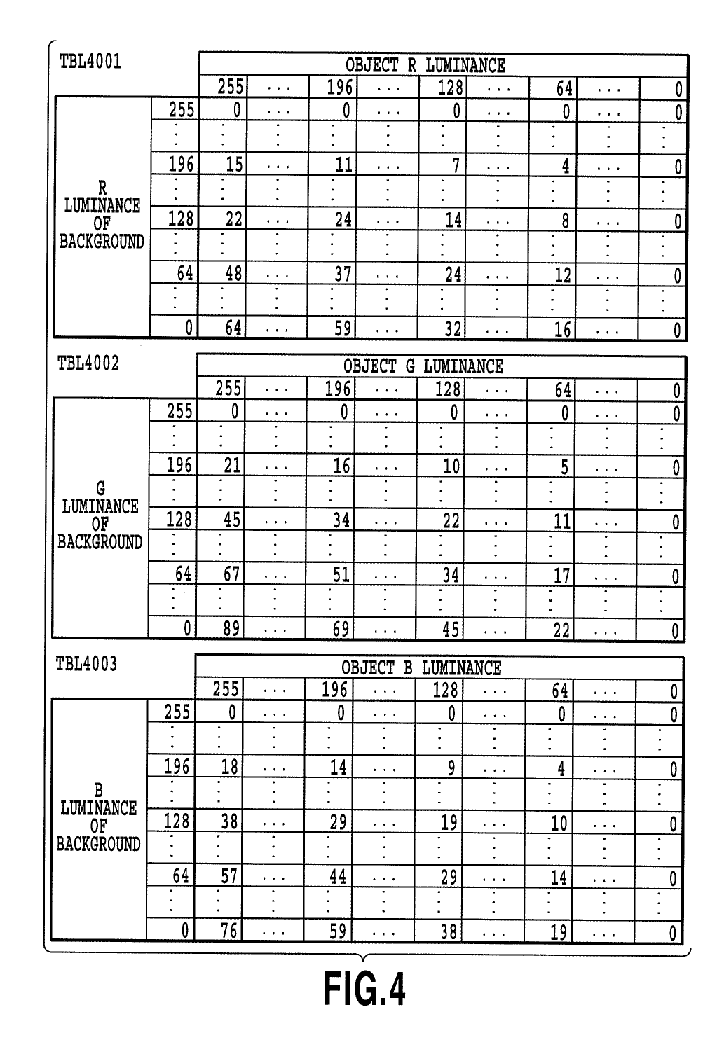

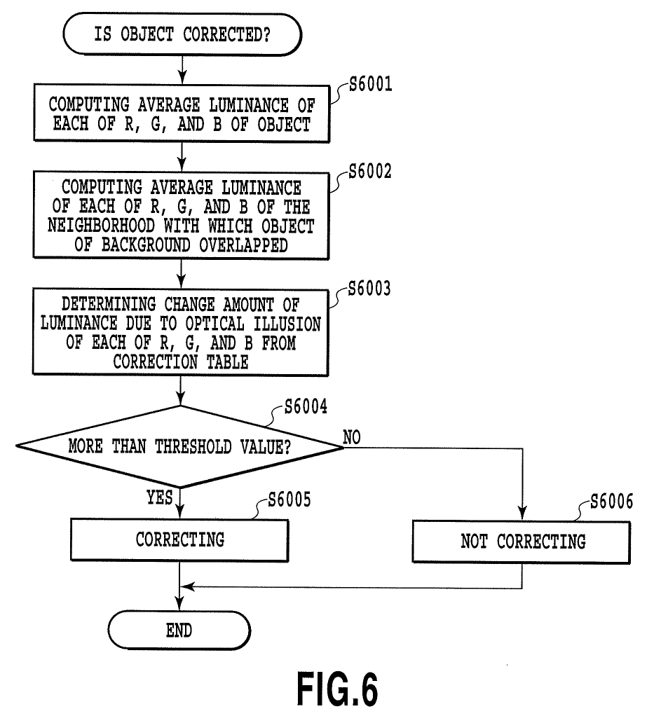

Subsequently, in the present embodiment, an example of step S3005 judging whether to perform correction of an object will be described according to a flow chart of FIG. 6 with reference to FIG. 1, FIG. 2, and FIG. 4. This process is performed by the CPU 1015.

FIG. 4 illustrates a LUT indicating a change amount of luminance in appearance due to a optical illusion stored in the evaluating-table storing memory 1032, which will be used in the process of step S6003 in FIG. 6.

In FIG. 4, TBL4001 is the LUT indicating the change amount of the luminance in appearance of the object of interest due to the optical illusion against the luminance of R of the background in the case that the color of the object of interest is decomposed into R, G, and B. By using this LUT, the change amount of the luminance in appearance due to the optical illusion can be calculated from the luminance of R of the object of interest and the luminance of R of the background.

In the case of the luminance of R of the object being 128 and the luminance of R of the background being 64, as an example, the change amount of the luminance in appearance of R of the object can be calculated to be 24 by using the change amount LUT TBL4001. The appearance can be prevented from becoming bright too much by reducing the luminance of R of the object of interest by the change amount. Likewise, TBL4002 is the change-amount LUT of the luminance in appearance due to the optical illusion against the luminance of the background G, and TBL4003 is the change-amount LUT of the luminance in appearance due to the optical illusion against the luminance of background B.

Based on the color information of the object of interest included in the attribution information of the object in the PDL-data memory 1017, the average luminance (average value of luminance) of all the pixels is computed, and is stored in the attribution information of the object in the PDL-data memory 1017 (S6001).

Likewise, based on the size information and the position information of the object of interest, the average luminance is computed also with respect to the background and other objects with which the objects in the neighborhood of the object of interest have overlapped and is stored in the attribution information of the object in the PDL-data memory 1017 (S6002).

Subsequently, the amount of the optical illusion of the object of interest is calculated using the table in FIG. 4 based on the average luminance of the object of interest and the average luminance of the neighborhood thereof (S6003). Specifically, by using the two average luminance values, the amount of the optical illusion of the object of interest corresponding to this data is calculated from TBL4001, TBL4002 and TBL4003, each of which is the change amount LUT of the luminance in appearance due to the optical illusion stored in the evaluating-table storing memory 1032.

Performed is comparison whether the change amount of the luminance in appearance due to the optical illusion of the object of interest (the amount of the optical illusion) is more than an arbitrary threshold value based on the output properties of every output device which is a record display device (a printing device, a display device in the present embodiment) (S6004). For example, performed is the comparison whether the change amount has exceeded the threshold value which is 5% of the maximum change amount of each color from the change amount LUT TBL4001, TBL4002 and TBL4003.

If the change amount of the luminance in appearance due to the optical illusion of the object of interest has exceeded this threshold value, it is judged that the correction is necessary (S6005). On the other hand, if the change amount of the luminance in appearance due to the optical illusion of the object of interest has not exceeded this threshold value, it is judged that the correction is not necessary (S6006).

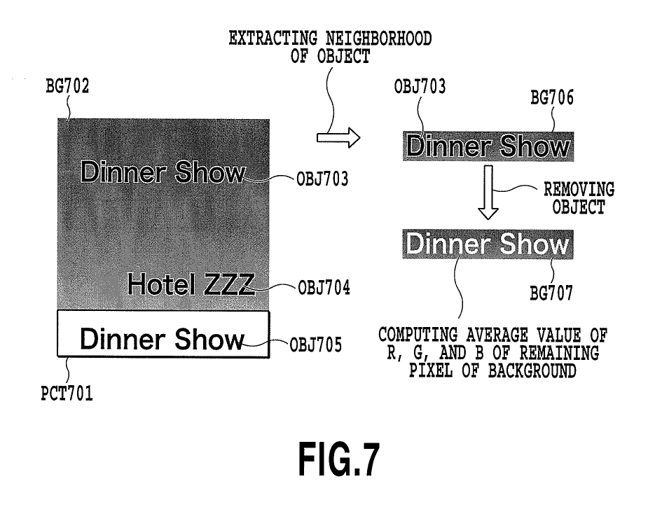

FIG. 7 illustrates an example of step S6002 which extracts the background overlapping with the object.

In FIG. 7, reference character PCT 701 denotes an overall image data, and includes a background data BG 702, character objects OBJ703, OBJ704, and OBJ705. On this character object OBJ703, the process which extracts the background for calculating the average luminance of the background for the correction of the optical illusion is as follows.

The CPU 1015 extracts all the pixels in the neighborhood area BG706 of the character object OBJ703 from the position information and the size information of the character object OBJ703 included in the attribution information of the object in the PDL-data memory 1017.

Next, the character object OBJ703 will be extracted from the neighborhood area BG706, and the average luminance of all the pixels of the background BG707 of the remaining portion will be computed.

Thus, the background which overlaps with the object is extracted.

<Luminance Correction of an Object>

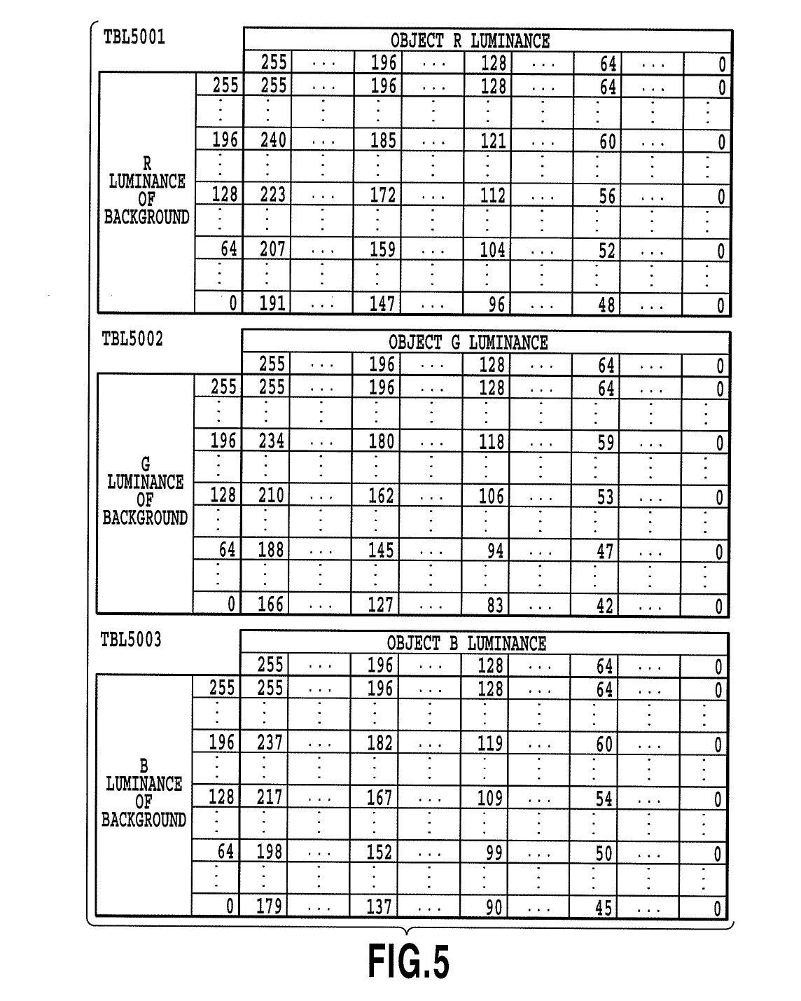

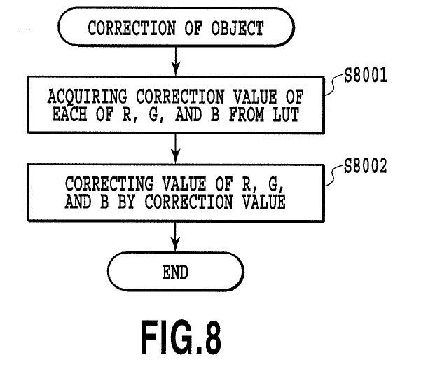

The correction processing of an object in step S3006 in the first embodiment of the present invention will be described according to a flow chart of FIG. 8 with reference to FIG. 1, FIG. 2, and FIG. 5. This correction processing is performed by the CPU 1015.

FIG. 5 illustrates a correction value LUT stored in the correction LUT (look-up table) storing memory 1033 which is used in step S8002 in FIG. 8.

In FIG. 5, TBL5001 is the correction value LUT in which the luminance (correction value) of R to be corrected of the object of interest against the luminance of R of the background is recorded in the case that the color of the object of interest is decomposed into R, G, and B. By using this LUT, the value of the luminance to be corrected (correction value) can be calculated from the luminance of R of the object and the luminance of R of the background.

In the case of the luminance of R of the object being 128 and the luminance of R of the background being 64, as an example, the value of the luminance of R of the object to be corrected can be calculated to be 104 using the correction value LUT TBL5001. The correction, here, is to alter the luminance value of R of the object into this correction value 104. That is, in this way, the correction is to compensate the luminance in appearance of R of the object which changes with the luminance of R of the background so that the change of the luminance in appearance of R of the object may be reduced in the case that the object is disposed against the background of the maximum luminance.

Likewise, TBL5002 is the correction value LUT recording the correction luminance of G of the object of interest in the luminance of G of the background. Likewise, TBL5003 is the correction value LUT recording the correction luminance of B of the object of interest in the luminance of B of the background.

The correction luminance O′ of the object stored in the correction value LUT TBL5001, TBL5002, and TBL5003 is one which is computed by the following formula, for example.

O′=O (1+K×(B−255)/255) (1-1)

where,

O′: Correction luminance of the object,

O: Luminance of the object,

K: Correction factor,

B: Luminance of the background.

The correction factor K is a different value for each of the color-separated red, green and blue. The correction factor K is a coefficient acquired by an approximation calculation based on a measurement of the actual state of the optical illusion.

Hereinafter, the detail of step S6002 will be described using FIG. 8.

First, acquired is the average luminance of the object of interest included in the attribution information of the object in the PDL-data memory 1017, which has been computed and stored in step S6001 in FIG. 6. Likewise, acquired is the average luminance of other overlapping objects or the background, which has been computed and stored in step S6002 in FIG. 6. Furthermore, the correction value of each of R, G, and B is acquired from the correction value LUT stored in the correction LUT storing memory 1033 based on the average luminance of the object of interest and the average luminance of other overlapping objects or the background (S8001). As the above-mentioned correction value LUT, TBL5001 TBL5002 and TBL5003 of FIG. 5 are used.

Then, the luminance of the object of interest is altered into the correction value acquired by step S8001, and the correction value is stored in the brightness information in the color information of the object in the PDL-data memory 1017 (S8002).

As another embodiment, γ correction based on the output properties of every output device (printing device, display device in the present embodiment) may be further performed at the same time on the correction luminance O′ of the object. If doing like this, the process can be reduced as compared with the case where the correction of the optical illusion and the γ correction based on the output properties are performed doubly on the object for which the correction of the optical illusion is performed.

Furthermore, if the correction of the optical illusion is performed according to the formula (1-1) mentioned above, the correction of the optical illusion can be performed also by performing computation and computing the correction value in step S8002 in FIG. 8 even if the LUT is not used. The formula mentioned above is a linear formula, but conversely, will be nonlinear strictly in the case of the density of the background being deep. Accordingly, in the case of using the LUT, if the experimental value in consideration of the state of the more actual optical illusion is made to be applied to the LUT and the correction value is made to be acquired using this LUT, the more exact correction of the optical illusion will be possible.

As described above, it becomes possible to keep the brightness/hue in appearance of the object of interest uniform by suppressing the effect of the optical illusion even if the object of interest is overlapped with the background part of any color.

In the present embodiment, the print processing in which the optical illusion is corrected has been described. However, using the PDF creating part 1010 of FIG. 1, the data with the optical illusion corrected may be converted into a PDF format, and the converted data may be stored in the HDD 1051.

### Second Embodiment

Hereinafter, the second embodiment of the present invention will be described using figures.

With respect to the overall configuration of the image forming system 10, the description will be omitted since the configuration is the same as that of the first embodiment.

<Print Processing with an Optical Illusion Corrected>

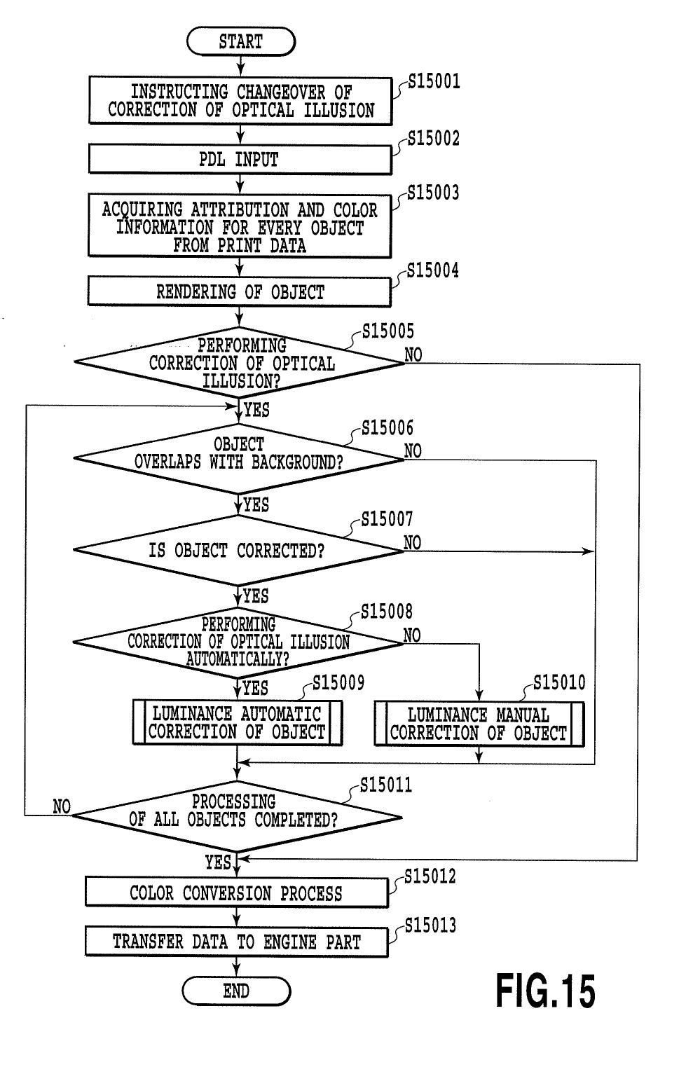

Print processing of the present embodiment with the optical illusion corrected will be described according to a flow chart of FIG. 15 with reference to FIG. 1 and FIG. 2. The print processing with the optical illusion corrected in the present embodiment is performed by the CPU 1015.

First, performed is an input display via panel 2002 to advise a specific user such as an administrator of the image forming system 10 to input a selection instruction whether to perform the correction processing of the optical illusion automatically, or to perform manually, or to perform nothing. When the selection instruction is made by the specific user, the content of the instruction selected by this user is stored in the RAM 1016 (S15001).

Subsequently, the image data transmitted via the printer driver from the information processing device 1001 is inputted via the receiving buffer 1002 as the data of the PDL format (S15002).

Subsequently, the CPU 1015 performs processing according to the program stated in the intermediate data object creating part 1005 so as to perform the processing of the inputted data. Specifically, with respect to each image object, such as a figure or a character, image data, or the like, the intermediate data object is generated in the intermediate data object memory 1018. At the same time, the attribution information of each object is acquired from the PDL data (S15003). In the attribution information of this object, the position information, the size information, and the color information are included.

Subsequently, after the intermediate data object has been generated in the intermediate data object memory 1018 with respect to all the image objects within one page, the rendering processing is performed according to the program stated in the rendering data creating part 1006 (S15004). Here, the intermediate data object is developed into the rendering data (bit map data) in the rendering data memory 1019.

In step S15001, it is checked whether to perform the correction processing of which the selection instruction has been instructed by the specific user (S15005). If “not to perform” is selected, the process will progress to the process of step S15012.

Subsequently, with respect to the object of interest, it is detected whether the object of interest has overlapped with other objects based on the position information and the size information included in the attribution information of the object in the PDL-data memory 1017 (S15006). The detail is the same as the process described in the item <Judgment whether an object has overlapped with a background> of the first embodiment and the description thereof is omitted. In the present embodiment, since an example of the process on the basis of the white (luminance is the maximum) is described, it is judged whether the object of interest has overlapped with other objects of the color other than the white. As a result of the detection in step S15006, in the case that it is judged that the object of interest has not overlapped with other objects, the process progresses to the process of step S15011.

On the other hand, as a result of the detection in step S15006, in the case that it is judged that the object of interest has overlapped with other objects or the background, the correction judgment processing of the object of interest is performed (S15007). The detail of this process is the same as the process described in the item <Judgment whether to perform correction of an object> in the first embodiment and the description is omitted. As a result of this judging process, the process progresses to the process of step S15011 in the case that it is judged that the correction is not performed.

On the other hand, as a result of the above-mentioned correction judgment processing, in the case that it is judged that the correction is performed, it is further checked whether to perform automatically or manually the correction processing selected by the specific user in step S15001 (S15008).

If “to perform automatically” is selected, the luminance correction of the object of interest is performed automatically (S15009). The detail of this process is the same as the process described in the item <Luminance correction of an object> in the first embodiment, and the description is omitted.

On the other hand, if “to perform manually” is selected, the luminance correction of the object of interest is performed manually (S15010). The detail of this process will be described later in the item <Luminance manual correction of an object>.

Hereinafter, likewise with respect to all the objects, the correction judgment and the correction processing (processes from step S15006 to S15010) are performed (S15011).

If the process is completed with respect to all the objects, the color conversion process is performed on the data after the correction in the image-processing part 1009, and after that, and screen processing is then performed (S15012).

The record signal with the optical illusion corrected by the process mentioned above is sent to the engine part 1040 via the engine transferring part 1025 (S15013).

<Luminance Manual Correction of an Object>

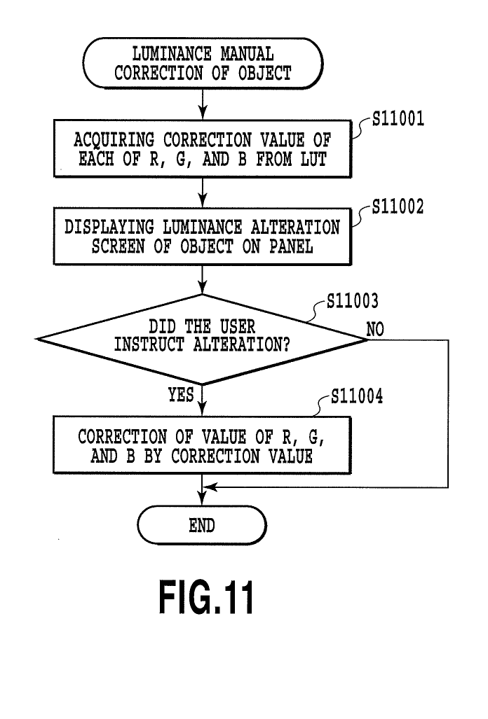

Hereinafter, a manual correction process S15010 of the object of the second embodiment will be described according to a flow chart of FIG. 11 with reference to FIG. 1 and FIG. 2. This manual correction process of the object is performed by the CPU 1015.

First, acquired is the average luminance of the object of interest included in the attribution information of the object in the PDL-data memory 1017, which has been computed and stored in step S6001 in FIG. 6. Likewise, acquired is the average luminance of other overlapping objects or the background, which have been computed and stored in step S6002 in FIG. 6. Furthermore, using the average luminance of the object of interest and the average luminance of other overlapping objects or the background, the correction value of each of R, G, and B is acquired from the correction value LUT stored in the correction LUT storing memory 1033 (S11001). As the above-mentioned correction value LUT, TBL5001, TBL5002 and TBL5003 of FIG. 5 are used.

Then, the correction value acquired in step S11001 is set to the default, and an object luminance correction screen 13001 is displayed on the panel 2002 via the panel I/F part 1026 (S11002).

Subsequently, it is checked whether the user has instructed the alteration of the luminance of the object on the panel 2002 (S11003).

In the case that the user has instructed the alteration of the luminance of the object, the luminance of the object of interest is altered into the correction value set up by the user on the object luminance correction screen, and is stored in the brightness information in the color information of the object in the PDL-data memory 1017 (S11004).

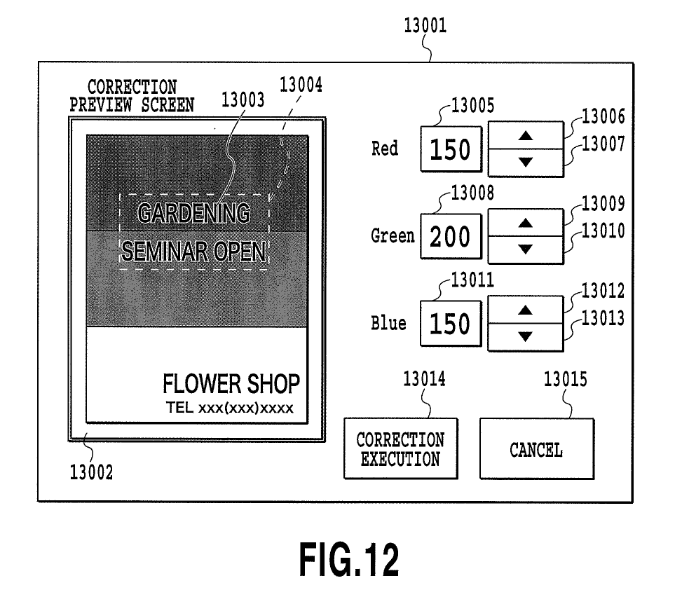

Here, in FIG. 12, an example of the luminance correction screen of the object displayed on the panel 2002 in step S11002 is illustrated.

The luminance correction screen 13001 illustrated in FIG. 12 includes the following display components.

Reference numeral 13002 denotes a preview screen where a preview of the image data is displayed. Reference numeral 13004 denotes a frame for specifying and displaying an object to be corrected 13003. Reference numeral 13005 denotes a text box where a value of the luminance of Red of the object to be corrected is displayed. Reference numeral 13006 denotes a button which increases the value in the text box. Reference numeral 13007 denotes the button which decreases the value in the text box. Reference numeral 13008 denotes the text box where the value of the luminance of Green of the object to be corrected is displayed. Reference numeral 13009 denotes the button which increases the value in the text box. Reference numeral 13010 denotes the button which decreases the value in the text box. Reference numeral 13011 denotes the text box where the value of the luminance of Blue of the object to be corrected is displayed. Reference numeral 13012 denotes the button which increases the value in the text box. Reference numeral 13013 denotes the button which decreases the value in the text box. Reference numeral 13014 denotes the button which instructs execution of the correction. Reference numeral 13015 denotes the button which instructs cancellation of the correction.

In the luminance correction screen 13001 configured as described above, which is displayed on the panel 2002, the user can perform various instructions. For example, on the object 13003, when values of the text boxes 13005, 13008 and 13011 are altered, the luminance of the object 13003 in the preview screen 13002 is altered. Thus, it becomes possible to instruct the execution of the correction or the cancellation, after actually checking visually.

As described above, in the present embodiment, the correction of the optical illusion according to the requests of the user can be realized by providing a function for the user to alter the correction luminance of the optical illusion.

### Third Embodiment

Hereinafter, the third embodiment of the present invention will be described using figures.

<Print Processing with an Optical Illusion Corrected in a Variable Data Print>

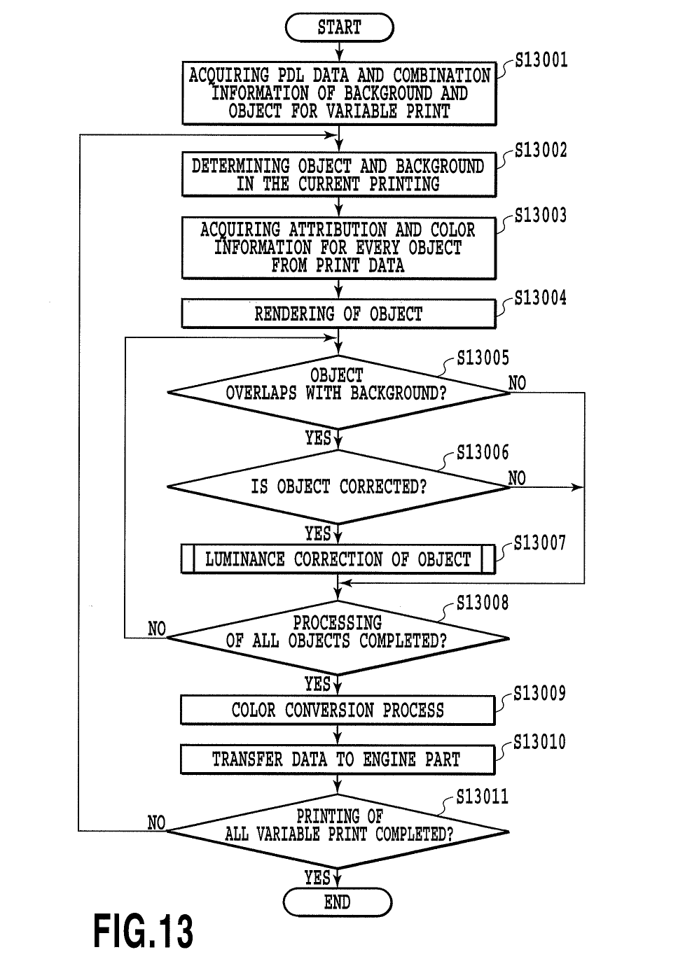

Here, print processing with an optical illusion corrected in a variable data print of the present embodiment will be described according to a flow chart of FIG. 13 with reference to FIG. 1 and FIG. 2. The print processing with the optical illusion corrected in the variable data print in the present embodiment is performed by the CPU 1015.

First, combination information of the object and the background, and the image data of the PDL, which have been transmitted from the information processing device 1001 via the printer driver, are inputted into the CPU 1015 via the receiving buffer 1002. The information and the data inputted into the CPU 1015 are command-analyzed to be stored in the PDL-data memory 1017 according to the program stated in the command analyzing part 1004 (S13001).

From the combination information of the object and the background, the object and the background for printing this time are specified (S13002).

Subsequently, in the object and the background selected in this printing, the data processing thereof is performed according to the program stated in the intermediate data object creating part 1005. Specifically, with respect to each image object, such as a figure and a character, image data, or the like, the intermediate data object is generated in the intermediate data object memory 1018. And at the same time, the position information, the size information, and the color information of each object are acquired from the PDL data (S13003).

After the intermediate data object has been generated in the intermediate data object memory 1018 with respect to all the image objects in one page, the rendering processing is performed according to the program stated in the rendering data creating part 1006 (S13004). Here, the intermediate data object is developed into the rendering data (bit map data) in the rendering data memory 1019.

Subsequently, with respect to the object of interest, it is detected whether the object of interest has overlapped with other objects based on the position information and the size information included in the attribution information of the object in the PDL-data memory 1017 (S13005). The detail of this process is the same as the process described in the item <Judgment whether an object has overlapped with a background> in the first embodiment, and the description thereof is omitted.

In the present embodiment, since an example of the process on the basis of the white (luminance is the maximum) is described, it is judged whether the object of interest has overlapped with other objects of the color other than that. As a result of the detection in step S13005, in the case that it is judged that the object of interest has not overlapped, the process progresses to the process of step S13008.

On the other hand, as a result of the detection in step S13005, in the case that it is judged that the object of interest has overlapped with other objects or the background, the correction judgment processing of the object is performed (S13006). The detail of this process is the same as the process described in the item <Judgment whether to perform correction of an object> in the first embodiment, and the description thereof is omitted.

As a result of this judging process, in the case that it is judged that the correction is not performed, the process progresses to the process of step S13008.

On the other hand, as a result of the above-mentioned judging process, in the case that it is judged that the correction is performed, the correction processing is performed (S13007). The detail of this process is the same as the process described in the item <Luminance correction of an object> in the first embodiment, and the description thereof is omitted.

Hereinafter, likewise with respect to all the objects, the correction judgment and the correction processing (steps S13005 to S13007) are performed (S13008).

If the process is completed with respect to all the objects, the color conversion process is performed by reflecting the brightness information of the corrected color altered by step S13007 in the image-processing part 1009 and after that, the screen processing is performed (S13009).

After the process in step S13009, the processed data are sent to the engine part 1040 via the engine transferring part 1025 (S13010).

Hereinafter, likewise with respect to all the combinations of the objects recorded in the PDL-data memory 1017 and the background, the variable data print processes (steps S13002 to S13010) are performed (S13011).

As described above, when realizing the successive print processing by successively altering the contents of the object inserted (fitted) in the master document like the variable data print process, the present embodiment can realize the correction processing of the optical illusion according to the altered contents of the object.

### Fourth Embodiment

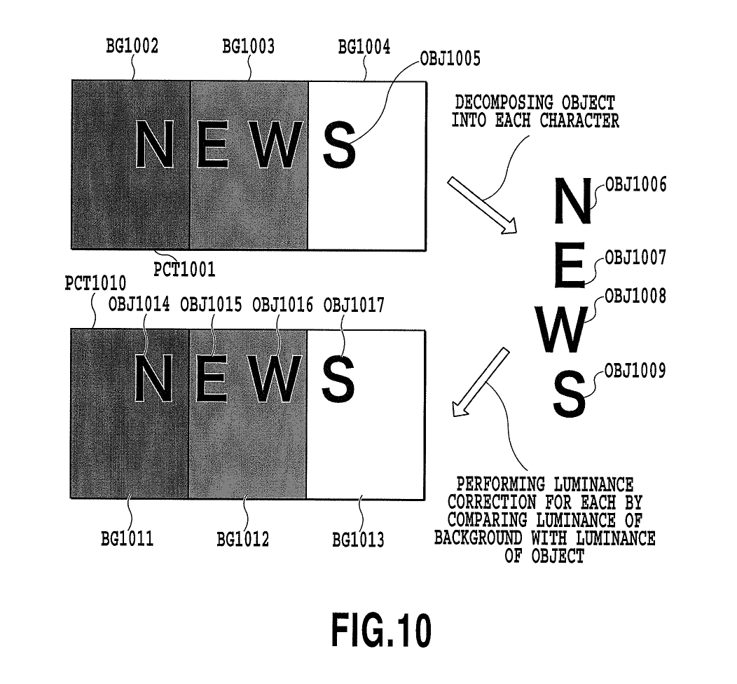

Hereinafter, a fourth embodiment of the present invention will be described using FIG. 10 and other figures.

FIG. 10 illustrates an example in which an object is decomposed and the correction of the optical illusion is performed.

In FIG. 10, reference character PCT1001 is an overall image data, and includes a background data BG1002, BG1003 and BG1004 having a different luminance, and a character object OBJ1005. In the case of there being the extreme difference of luminance in the background etc. which overlaps with the object like this, the effect of the optical illusion can be suppressed more effectively by decomposing the object and performing the correction of the optical illusion for each of the decomposed objects rather than correcting by the average luminance of the backgrounds.

Then, the CPU 1015 decomposes a character object OBJ1005 having characters of “NEWS” into each of the characters. That is, the CPU 1015 decomposes the character object OBJ1005 into a character object OBJ1006 of “N”, a character object OBJ1007 of “E”, a character object OBJ1008 of “W”, and a character object OBJ1009 of “S.”

Then, while performing the same correction processing of the optical illusion on each character object as that of the first embodiment, the CPU 1015 creates a print-data PCT1010.

In the print-data PCT1010, the background data BG1011, BG1012 and BG1013, and the character object OBJ1014, OBJ1015, OBJ1016 and OBJ1017 have been printed as illustrated in the same figure. The correction processing is performed, based on the brightness information, for the character object OBJ1014 by using the background BG1011 as the background of the neighborhood thereof, performed for the character object OBJ1015 and OBJ1016 by using the background BG1012 as the background of the neighborhood thereof, and performed for the character object OBJ1017 by using the background BG1013 as the background of the neighborhood thereof. Since the correction of the optical illusion is made for every component of the objects decomposed in this way, more suitable correction is attained.

### Fifth Embodiment

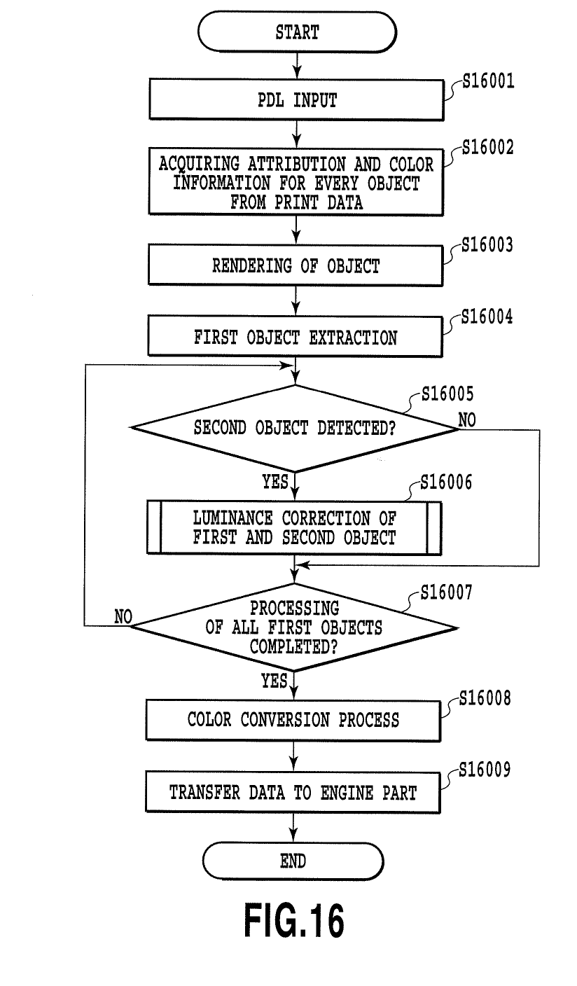

Hereinafter, the print processing of the optical illusion correction of the fifth embodiment of the present invention will be described according to a flow chart of FIG. 16 with reference to FIG. 1 and FIG. 2. The print processing of the optical illusion correction in the present embodiment is performed by the CPU 1015.

First, the image data transmitted via the printer driver from the information processing device 1001 is inputted into the CPU 1015 via the receiving buffer 1002 as the data of the PDL format (S16001).

Subsequently, according to the program stated in the intermediate data object creating part 1005, the process of the inputted data is performed. Specifically, with respect to each image object, such as a figure and a character, image data, or the like, the intermediate data object is generated in the intermediate data object memory 1018. At the same time, the attribution information of each object is acquired from the PDL data (S16002). In this attribution information of the object, the position information, the size information, and the color information are included.

Subsequently, after the intermediate data object has been generated in the intermediate data object memory 1018 with respect to all the image objects in one page, the rendering processing is performed according to the program stated in the rendering data creating part 1006 (S16003). Here, the intermediate data object is developed into the rendering data (bit map data) in the rendering data memory 1019.

Subsequently, with respect to objects in one page, all the objects (first object) with which other objects have not overlapped are extracted (S16004).

Furthermore, based on the position information and the size information which are included in the attribution information of the object in the PDL-data memory 1017, a second object which has overlapped with the first object in a state where the first object is included in the inside of the second object is detected (S16005). In the present embodiment, since an example of the process on the basis of the white (luminance is the maximum) is described using the luminance of the object as the record value, it is judged whether there exists the overlapping with other objects of the color other than the white. As a result of the detection in step S16005, in the case that it is judged that there is no overlapping object, the process progresses to the process of step S16007.

On the other hand, as a result of the detection in step S16005, in the case that it is judged that there is the overlapping object, the luminance correction of the first object and the second object is performed (S16006).

The detail of this process will be described later in the item <Luminance correction of first and second object>.

Hereinafter, likewise with respect to all the first objects, the correction processing (steps S16005 to S16006) is performed (S16007).

If the process is completed with respect to all the first objects, the color conversion process is performed by reflecting the brightness information of the corrected color which has been altered in the process of step S16006 in the image-processing part 1009, and after that, the screen processing is performed (S16008).

The record signal in which the optical illusion has been corrected by the above process is sent to the engine part 1040 via the engine transferring part 1025 (S16009).

<Luminance Correction of First and Second Object>

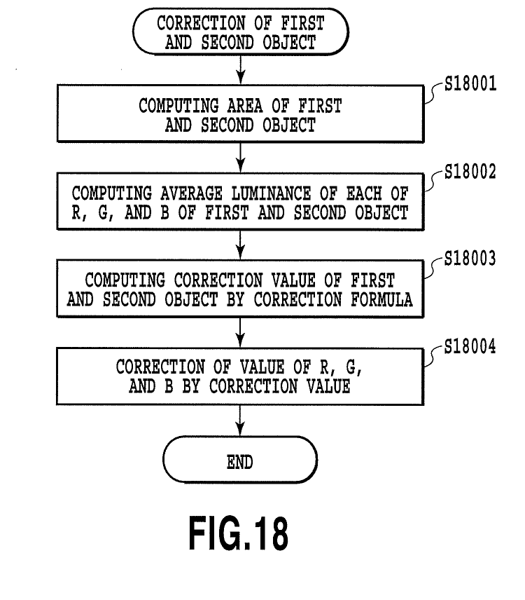

The luminance correction process of step S16006 of the first and the second object in the present embodiment will be described according to a flow chart of FIG. 18 with reference to FIG. 1 and FIG. 2. The luminance correction process of the first and the second object in the present embodiment is performed by the CPU 1015.

First, an area in which printing is performed is computed based on the size information of the first object, and the computed area is stored in the attribution information of the object in the PDL-data memory 1017. Furthermore, the actual printing area in consideration of the overlap of the first object is computed based on the size information of the second object, and the computed area is stored in the attribution information of the object in the PDL-data memory 1017 (S18001).

Subsequently, with respect to the first object and the second object, the average luminance for every color of R, G, and B is computed based on the color information included in the attribution information of the object in the PDL-data memory 1017. The computed average luminance for every color of R, G, and B, is stored in the attribution information of the object in the PDL-data memory 1017 (S18002).

Subsequently, in order to correct the optical illusion effect in consideration of the area of two objects, the correction values of the first object and the second object are computed from the area information and the average brightness information of the first object and the second object (S18003). The optical illusion correction value of the first object is calculated with the following computing formula.

‘O₁’=O₁×(1+K×(O₂−255)/255) (5-1),

K=K₁×A₂/(A₁+A₂) (5-2).

The optical illusion correction value of the second object is calculated with the following computing formula.

‘O₂’=O₂×(1+Q×(O₁−255)/255) (5-3),

Q=Q₁×A₁/(A₁+A₂) (5-4),

where,

O₁: Luminance of first object,

O₁′: Luminance of corrected first object,

O₂: Luminance of second object,

O₂′: Luminance of corrected second object,

K: Coefficient in consideration of area,

K₁: Coefficient,

A₁: Area of first object,

A₂: Area of second object,

Q: Coefficient in consideration of area,

Q₁: Coefficient.

As for coefficient K1 and Q1, the optimal values shall be determined in advance based on an experiment etc.

The correction value for every color of R, G, and B which are computed as mentioned above with respect to the first object and the second object is stored in the attribution information of the object in the PDL-data memory 1017 (S18004).

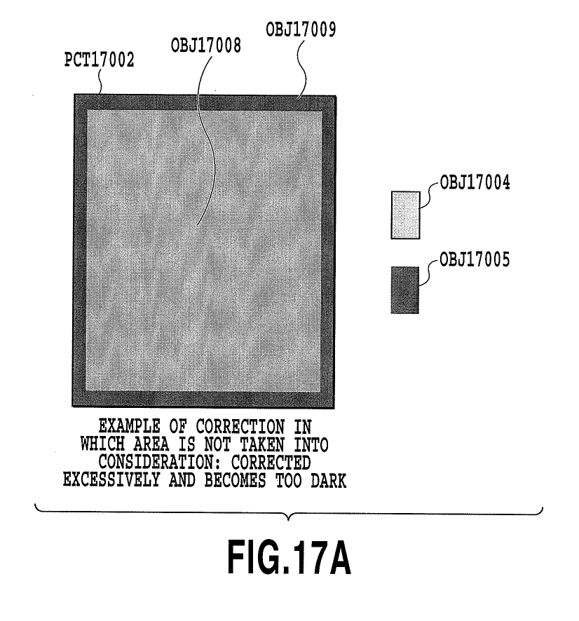

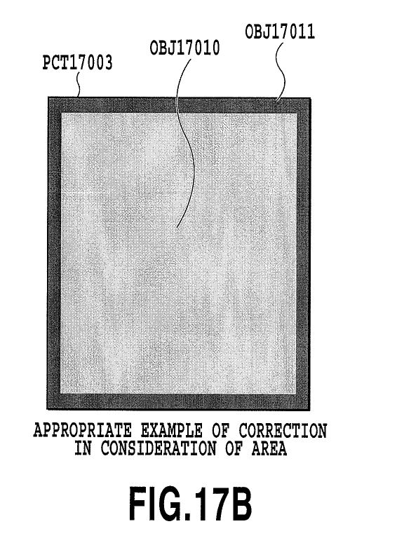

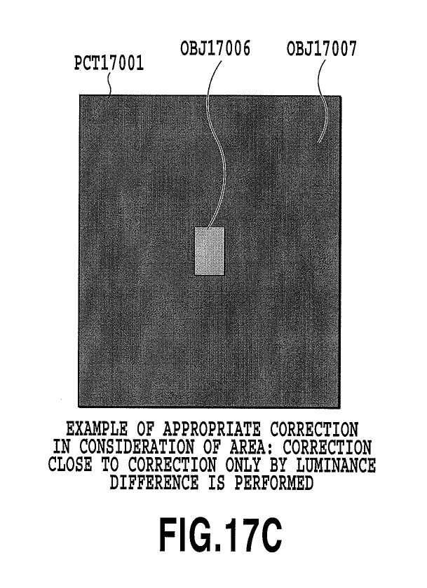

Examples of the optical illusion correction results in consideration of the effect due to the area of the object in the present embodiment are illustrated in FIG. 17A to FIG. 17C.

Each of PCT17001, PCT17002, or PCT17003, which is shown in FIG. 17A to 17C, includes two objects having the same luminance as the objects OBJ17004 and OBJ17005, respectively.

PCT17002 includes the first object OBJ17008 having the same luminance as OBJ17004 and the second object OBJ17009 having the same luminance as OBJ17005.

FIG. 17A is the figure in the case that the area of the first object OBJ17008 is quite large compared with the actual printing area of the second object OBJ17009 excluding the overlapping portion with the first object OBJ17008. This figure is the result of having corrected the first object OBJ17008 based on only the luminance difference regardless of the area. Since this figure has been corrected based on the luminance difference only, as the result, the luminance alteration has been performed excessively as the result of having corrected the first object OBJ17008 into the same luminance as OBJ17006 of PCT17001, and this figure has come to have the luminance which is different from OBJ17004 in appearance.

PCT17003 illustrated in FIG. 17B includes the first object OBJ17010 having the same luminance as OBJ17004 and the second object OBJ17011 having the same luminance as OBJ17005. FIG. 17B also, like PCT17002, is the figure in the case that the area of the first object OBJ17010 is quite large compared with the actual printing area of the second object OBJ17011 excluding the overlapping portion with the first object OBJ17010. As for the luminance of the first object OBJ17010, K becomes a small value because of A2<<A1 by the formula (5-2). The first object OBJ17010 is corrected by a small amount of correction compared with the correction by only the luminance difference based on the formula (5-1), and is corrected into the same luminance in appearance as OBJ17004 which is an independent object.

On the other hand, as for the second object OBJ17011, Q becomes almost equal to Q1 because of A2<<A1 by the formula (5-4) and the second object OBJ17011 is influenced by the luminance of the first object OBJ17010 due to the formula (5-3), and has the correction performed thereon.

PCT17001 illustrated in FIG. 17C includes the first object OBJ17006 having the same luminance as OBJ17004 and the second object OBJ17007 having the same luminance as OBJ17005. FIG. 17C is a figure in the case that the actual printing area of the second object OBJ17007 excluding the overlapping portion with the first object OBJ17006 is very large compared with the area of the first object OBJ17006. As for the luminance of the first object OBJ17006, K becomes almost equal to K1 because of A2>>A1 by the formula (5-2). The first object OBJ17006 is influenced by the luminance difference with the second object OBJ17007 due to the formula (5-1), and is corrected largely. Although the area is taken into consideration in this example, the same correction processing as the correction only by the luminance difference is performed. By this correction, the luminance has become the same in appearance as OBJ17004 which is the independent object.

On the other hand, as for the second object OBJ17007, Q becomes nearly 0 because of A2>>A1 by the formula (5-4) and as the result of the formula (5-3), the correction has been performed little.

Thus, in the present embodiment, the further correction of the optical illusion according to an area ratio is realized by taking the area of the object into consideration.

Although the various embodiments mentioned above have been described with the printing device supposed as the output device, the same effect is acquired by the same process also in the case of using a display device as the output device which is the record display device. In the case of using the display device as the output device, using the luminance of the object as a display value corresponding to the record value mentioned above, a corrected display signal is supplied to the display device.

According to the embodiments mentioned above, it becomes possible to correct the brightness/hue in appearance of the object of interest by suppressing the effect of the optical illusion even if the object of interest is overlapped on the background of any color.

### Other Embodiment

The object of the present invention is attained by a system or a computer (or a CPU and a MPU) in a device reading and executing a program code from a storage medium storing the program code which realizes processes of the flow charts illustrated in the embodiments mentioned above. In this case, the program code itself read from the storage medium will make the computer realize the functions of the embodiments mentioned above. Therefore, this program code and also a computer-readable storage medium in which the program code is stored and recorded will be included in the present invention.

As the storage medium for supplying the program code, for example, Floppy (registered trademark) disk, a hard disk, an optical disk, a magneto-optic disk, a CD-ROM, a CD-R, a magnetic tape, a nonvolatile memory card, a ROM, or the like, can be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-144710, filed Jun. 2, 2008, which is hereby incorporated by reference herein in its entirety.

What is claimed is:

1. An image processing device, comprising:
an evaluation unit for evaluating a record value of an object of interest and a background part thereof;
a unit for correcting the record value of the object of interest in order to correct an optical illusion of a human depending on a result of the evaluation by the evaluation unit; and
a unit for performing record with the corrected record value.

2. The image processing device according to claim 1, wherein the object of interest is a character object.

3. The image processing device according to claim 1, wherein the object of interest is a character of which the record display is performed on a different background image.

4. The image processing device according to claim 1, wherein the evaluation unit evaluates the record value and the difference thereof of the object of interest and the background part thereof.

5. The image processing device according to claim 1, wherein the evaluation of the record value is performed for each of colors color-separated from the object of interest and the background part thereof.

6. The image processing device according to claim 1, wherein the correction unit performs the correction according to an instruction of an operator.

7. The image processing device according to claim 1, further comprising an input displaying unit for performing display for receiving an input of an instruction by an operator about whether to perform the correction.

8. The image processing device according to claim 1, wherein correction processing of the correction unit is performed for every color-separated color.

9. The image processing device according to claim 1, comprising a developing unit for developing according to the corrected record value into a record signal, and inputting the record signal into a recording device.

10. An image processing device, comprising:
an evaluation unit that evaluates a record value of a second object in the neighborhood of a first object;
a unit that corrects the record value of the first and the second object in order to correct an optical illusion of a human depending on a result of the evaluation by the evaluation unit; and
a unit that performs record with the corrected record value.

11. The image processing device according to claim 10, wherein the evaluation unit evaluates the record value and the difference thereof of the first object and the second object.

12. The image processing device according to claim 10, wherein the evaluation unit evaluates an area of the first object and the second object.

13. The image processing device according to claim 10, wherein the record value to be evaluated is an average value of the first object and the second object.

14. The image processing device according to claim 10, wherein the evaluation of the record value is performed for each of colors color-separated from the first object and the second object.

15. The image processing device according to claim 10, wherein a correction value for the first object is determined depending on a result of the evaluation of the second object by the evaluation unit.

16. The image processing device according to claim 10, wherein a correction value for the second object is determined depending on a result of the evaluation of the first object by the evaluation unit.

17. The image processing device according to claim 10, wherein the correction unit performs the correction according to an instruction of an operator.

18. The image processing device according to claim 10, comprising an input displaying unit that performs display for receiving an input of an instruction by an operator about whether to perform the correction.

19. The image processing device according to claim 10, wherein correction processing of the correction unit is performed for each of colors color-separated.

20. The image processing device according to claim 10, comprising a developing unit that develops according to the corrected record value into a record signal, and inputs the record signal into a recording device.

21. An image processing method performed in an image processing device, the method comprising the steps of:
evaluating a record value of an object of interest and a background part thereof;
correcting the record value of the object of interest in order to correct an optical illusion of a human depending on a result of the evaluation by the evaluation step; and
performing record with the corrected record value.

22. An image processing method performed in an image processing device, the method comprising the steps of:
evaluating a record value of a second object in the neighborhood of a first object;
correcting the record value of the first and the second object in order to correct an optical illusion of a human depending on a result of the evaluation by the evaluation step; and
performing record with the corrected record value.

23. A computer-readable storage medium storing a program which causes a computer to execute the method according to claim 21.
